(19) United States
(12) Patent Application Publication
(10) Pub. No.: US 2007/0098957 A1
(43) Pub. Date: May 3, 2007

(54) Method for the preparation of self-cleaning removable surfaces

(76) Inventors: Wilhelm Barthlott, Bonn (DE); Christoph Neinhuis, Bonn (DE)

Correspondence Address: JACOBSON HOLMAN PLLC, 400 SEVENTH STREET N.W., SUITE 600, WASHINGTON, DC, 20004, US

(21) Appl. No.: 11/584,756

(22) Filed: Oct. 23, 2006

Related U.S. Application Data
(63) Continuation of application No. 11/047,741, filed on Feb. 2, 2005.
Application No. 11/047,741 is a continuation of application No. 09/926,184, filed on Dec. 31, 2001, now abandoned.

(30) Foreign Application Priority Data
Mar. 25, 1999 (DE) 199 13 602.5

(51) Int. Cl. B05D 3/02; G11B 5/64

(52) U.S. Cl. 428/141; 427/372.2

(57) ABSTRACT

The method for the preparation of self-cleaning surfaces having protrusions and recesses, wherein the distance between said protrusions is in a range of from 0.1 to 200 μm and the height of said protrusions is in a range of from 0.1 to 100 μm is performed by applying a solution, dispersion or emulsion containing a hydrophobic material which forms a self-cleaning surface by self-organization when the solvent is evaporated, followed by drying, wherein the material applied can be removed with detergents.

The present invention relates to a method for the preparation of self-cleaning surfaces.

The cleaning of the surfaces of objects is of considerable technical and economical importance, in part for optical and aesthetical reasons, and in part for technical reasons, especially if the surfaces are light-transmitting surfaces which must be cleaned from time to time for maintaining their function.

Many attempts have been made to create technical surfaces which are soil-repellent and/or self-cleaning. The manufacturers of polymer films or polymer sheets have tried to solve this problem by producing as smooth as possible surfaces and rendering those surfaces either extremely hydrophobic or extremely hydrophilic. Examples thereof include surfaces made of the extremely hydrophobic Teflon or the extremely hydrophilic “no-drop coatings” from which water and soil can flow off without forming drops.

CH-PS-26 82 58 describes water-repellent surfaces which exhibit a contact angle with water of more than 120°. They are obtained by applying powders, such as china clay, talcum, clay or silica gel, to a substrate, the powder being preliminarily hydrophobized by organic silicon compounds. The application is performed together with curable resins, or from solutions with organic solvents. Permanently hydrophobic surfaces cannot be prepared in this way. Also, no indications are found as to the grain sizes or grain size distribution of the powders. The properties or the surfaces thus obtained are compared with those of the leaves of nasturtium. In this comparison, it has to be noted that it had been neither known nor technically analyzable whereupon the properties of the leaf surface of nasturtium are based. Recently performed examinations have shown that nasturtium has an extremely fine ultrastructure with structural elements smaller than 2 μm.

U.S. Pat. No. 3,354,022 describes a water-repellent surface having protrusions and recesses and an air content of at least 60% for which a surface contact angle of more than 90° is found.

DE-PS-10 23 217 describes a mold for the preparation of molded parts having a rough surface. The mold is to serve for the preparation of molded parts made of rubber or plastic having a rough surface. Thus, the walls of the mold are coated with coarse corundum powder and a stoving paint. The molds yield products having occasional recesses and hence improved adhesive properties. The usual vulcanization skin is even avoided. For example, the surfaces thus obtained are readily inscribed. Thus, the products are surely not self-cleaning with moving water.

JP-A-62-191447 describes a method for increasing the water-repellency of a surface. Thus, a plasma polymer film is applied, roughened by etching, and then a second plasma polymer film is applied.

JP-A-3-174279 (Abstract) describes a method for the preparation of matt decorative surfaces on sheets or films. They are prepared using paints which are partially cured by ionizing radiation and in which unspecified patterns are impressed in an unspecified way. Curing is then completed by further irradiation.

Applicant's extensive examinations have provided the surprising result that it is technically possible to artificially render the surfaces of objects self-cleaning by providing them with an artificial surface structure of protrusions and recesses, wherein care has to be taken that the distance between said protrusions of the surface structure is in a range of from 0.1 to 200 μm, preferably from 0.1 to 100 μm, and the height of said protrusions is in a range of from 0.1 to 100 μm, preferably from 0.1 to 50 μm, and care has to be taken that said protrusions consist of hydrophobic polymers or permanently hydrophobized materials, and care is taken that said protrusions cannot be removed by water or water with detergents (cf. WO 96/04123).

It has been the object of the present invention to provide a method for the preparation of self-cleaning surfaces which can be removed with detergent solutions. This object is achieved by a method having the features of claim 1.

The method according to the invention for the preparation of self-cleaning surfaces having protrusions and recesses, wherein the distance between said protrusions is in a range of from 0.1 to 200 μm and the height of said protrusions is in a range of from 0.1 to 100 μm, is based on the application of a hydrophobic material which forms a self-cleaning surface by self-organization when the solvent is evaporated to a surface followed by drying, wherein the material applied can be removed with aqueous detergent solutions. The hydrophobic material may be in the form of a solution, dispersion or emulsion.

“Removable by detergents” means that the material applied can be removed by the action of aqueous detergent solutions, at least upon prolonged action, by dissolving at least parts of the material applied. Such materials applied according to the invention can also be removed mechanically, for example, by brushing, scratching or high-pressure cleaning with water.

In one embodiment, the hydrophobic material is a wax which forms a microstructured self-cleaning surface by self-organization.

In another embodiment, the solution, dispersion or emulsion contains solid particles. These may be themselves hydrophobic or hydrophilic when employed together with hydrophobic materials, such as waxes.

The application of the hydrophobic material may be effected by spraying, for example, using a spray can or a spray gun. Depending on the kind of the intended application, it may be advantageous for the hydrophobic material to be additionally oleophobic.

It is also possible to transport the hydrophobic material through a vapor-permeable surface by co-transportation with water.

The hydrophobic materials suitable for the method according to the invention include, in particular, longer-chain secondary alcohols and alkanediols, β-di-ketones, secondary ketones and long-chain alkanes. Particularly suitable are nonacosane-10-ol, nonacosane-7,10-diol, nonacosane-5,10-diol, hentriacontane-12,14-dione, hentriacontane-8,10-dione, palmitone and other hydrophobic substances which are soluble in volatile solvents and form a hydrophobic water-repellent surface by self-organization when these solvents are evaporated.

Of particular technical importance are self-cleaning surfaces of objects which are light-transmitting and which are to maintain their light-transmission for a long period of time for optical, aesthetical or technical reasons. In particular, the objects include light-transmitting glass-work on buildings, vehicles, solar collectors etc. The removability of the hydrophobic material is of advantage, in particular, when the self-cleaning properties are needed only temporarily, for example, during storage or shipping, but are otherwise undesirable, for example, for aesthetic reasons.

Also of economical and technical importance, however, is the preparation of self-cleaning surfaces for house facades, roofs, monuments and tents, and for interior coatings of silos, tanks or pipelines which either contain aqueous solutions or are readily cleaned without residues by moving water. The outer coatings of vehicles such as cars, trains or airplanes are also of interest.

Optimum results are achieved if the protrusions of the surface structures are close enough to one another to avoid contact of the recesses present between the protrusions with drops of water. If the protrusions of the surface structures are too close to one another or if the recesses are not profound enough, they again act as a closed surface and thus can be better wetted. Therefore, it should be sought that the height of the protrusions above the ground increase as the distance between the protrusions increases. The measurements performed so far have shown that good results are achieved within the claimed limits for the distances and heights of the protrusions. Surfaces having protrusions of from 0.1 to 50 μm for which the distance between the protrusions is from 0.1 to 100 μm yield optimum results.

The invention is further illustrated by the following Examples.

### EXAMPLE 1

Hentriacontane-14,16-dione as a 0.1% solution in hexane or ethyl acetate is sprayed onto an arbitrarily selected surface using a spray can or spray gun. While the solvent evaporates, the hentriacontane-14,16-dione forms crystals in the form of small tubes by self-organization, the majority of which have a diameter of 0.2 μm and a length of from 0.5 to 5 μm. This coating renders a wettable surface hydrophobic, and the contact angle is increased up to 160°. From such surfaces, contaminating particles are washed off by moving water, wherein the coating itself is also removed on a long-term basis. To increase the roughness of the coating, a hydrophilic (e.g., quartz powder) of hydrophobic powder (e.g., Teflon) can be admixed with the solution.

### EXAMPLE 2

Commercially available gypsum is mixed with water and a siliconate (Wacker BS 15) at a ratio of 1:10:2 (weight percent), followed by applying it with a paintbrush or roll. Drying up forms a microrough surface whose structure is determined by the acicular crystals of the gypsum. After the water has evaporated, these are covered by a layer of the hydrophobizing agent. The contact angles on such a surface are above 150°.

### EXAMPLE 3

Commercially available gypsum is mixed with water and a siliconate (Wacker Silikon WI) at a ratio of 1:10:0.5 (weight percent), followed by applying it with a spray gun. Drying up forms a microrough surface whose structure is determined by the acicular crystals of the gypsum. After the water has evaporated, these are covered by a layer of the hydrophobizing agent. The contact angles on such a surface are above 150°.

### EXAMPLE 4

A water-vapor-permeable polymer (e.g., polyurethane) is coated on one side thereof with a waxy substance (e.g., hentriacontane-14,16-dione) which is characterized by a capability of structure formation (see Example 1). If water is allowed to diffuse through the polymer, the wax is cotransported and forms the desired microstructures on the surface.

In this system, by using a sufficiently high amount of wax, a certain sustained effect can be achieved because damaged or eroded structures can be regenerated for some time.

1-10. (canceled)

11. A method of making an object having a removable, self-cleaning surface comprising coating an object with a surface layer of hydrophobic material having protrusions and recesses, wherein the distance between said protrusions is in a range of from 0.1 to 200 μm and the height of said protrusions is in a range of from 0.1 to 100 μm, whereby the surface layer is both
self cleaning and
removable from the object (i) with water alone or (ii) with water-containing detergents.

12. The method of claim 11, wherein the coating is done by applying to the object a solution, dispersion, or emulsion containing the hydrophobic material and a liquid followed by evaporating the liquid, whereupon the hydrophobic material forms the self-cleaning surface having the protrusions and recesses by self-organization when the liquid is evaporated.

13. The method according to claim 11, characterized in that said hydrophobic material is a wax.

14. The method according to claim 11, characterized in that said hydrophobic material comprises waxy substances, such as primary or secondary alcohols and alkanediols, β-diketones, secondary ketones and long-chain alkanes.

15. The method according to claim 11, characterized in that said solution, dispersion or emulsion contains solid particles.

16. The method according to claim 11, characterized in that said application of the solution, dispersion or emulsion is effected by spraying.

17. The method according to claim 16, characterized in that said application is effected using a spray can or spray gun.

18. The method according to claim 11, characterized in that said hydrophobic material is additionally oleophobic.

19. The method according to claim 11, characterized in that the hydrophobic material is selected from the group consisting of secondary alcohols, alkanediols, β-diketones, secondary ketones, and long-chain alkanes.

20. The method according to claim 11, characterized in that the hydrophobic material is selected from the group consisting of nonacosane-10-ol, nonacosane-7,10-diol, nonacosane-5,10-diol, hentriacontane-12,14-dione, hentriacontane-8,10-dione, and palmitone.

21. A product made by the method of claim 11.
